(19) United States
(12) Patent Application Publication
(10) Pub. No.: US 2025/0006438 A1
(43) Pub. Date: Jan. 2, 2025

(54) ELECTRICAL SWITCH ARRANGEMENT FOR REDUCING ARC ENERGY AND EROSION IN A CONTACT SYSTEM

(71) Applicant: Eaton Intelligent Power Limited, Dublin 4 (IE)

(72) Inventors: Toni OTT, Neckargemünd (DE); Marco KNAB, Eberbach (DE); Lars WISCHGOLL, Gemmingen (DE)

(21) Appl. No.: 18/697,713

(22) PCT Filed: Sep. 30, 2022
(86) PCT No.: PCT/EP2022/025456

§ 371 Date: Apr. 1, 2024

Related U.S. Application Data
(60) Provisional application No. 63/250,419, filed on Sep. 30, 2021.

(30) Foreign Application Priority Data
Sep. 30, 2021 (DE) 10 2021 125 372.1
Sep. 22, 2022 (DE) 10 2022 124 409.1

(51) Int. Cl. H01H 9/42; H01H 1/20; H01H 13/12; H01H 19/10

(52) U.S. Cl. CPC H01H 9/42; H01H 1/20; H01H 13/12; H01H 19/10

(57) ABSTRACT

An electrical switch arrangement for electrically connecting a first electrical conductor to a second electrical conductor. The electrical switch arrangement includes a first circuit path having a first electrical resistance or impedance; and a second circuit path having a second electrical resistance or impedance that is lower than the first electrical resistance or impedance. The electrical switch arrangement is configured to provide a connection sequence for electrically connecting the first and second electrical conductors. During the connection sequence, the electrical switch arrangement moves from a first electrical connection state, sequentially through second and third electrical connection states, to a fourth electrical connection state.

### TECHNICAL FIELD

The present disclosure relates generally to electrical devices for providing circuit interruptions such as switching systems.

### BACKGROUND

Electrical systems such as switch systems are used to provide circuit interruptions. When such systems are electrically connected or electrically disconnected while under electrical load, arcing can occur. Arcing can cause component erosion that negatively impacts system performance. In certain cases where the arc energy is sufficiently high, ionization related short circuiting may occur. Improvements in this area are desirable.

### SUMMARY

The present disclosure relates generally to an electrical connection arrangement including a multi-step contact system that is sequenced to reducing arc energy resulting from electrical connection and disconnection of the system under electrical load. The electrical connection arrangement can also reduce erosion of the contact system resulting from electrical arcing. The electrical connection arrangement includes first and second circuit paths having different electrical resistances or impedances. When making an electrical connection under load, the circuit path with the higher resistance is connected before the circuit path with the lower resistance to reduce arc energy. Similarly, when making an electrical disconnection under load, the circuit path with the lower resistance is disconnected before the circuit path with the higher resistance to reduce arc energy. The term “resistance” as used herein is defined generally to represent a comprehensive expression of any and all forms of opposition to a flow of electrons in electrical systems. For example, in direct current systems, resistance can be quantified using real values (e.g., resistive Ohms); in alternating current systems, resistance can represent a component of impedance, wherein impedance is quantified by a combination of real values (e.g., resistive Ohms) and imaginary values

In one example, the electrical connection arrangement in integrated in a rotary type switch where the resistances of the circuit paths are made different by providing first and second contacts made of different materials having different electrical resistivities. In another example, the electrical connection arrangement can be integrated in a linear switch, where the resistances of the circuit paths are made different by providing pad contacts made of different materials having different electrical resistivities. In certain examples, the material having a higher electrical resistivity (i.e., the lower electrical conductivity) also is more erosion resistant that the material having the lower electrical resistivity (i.e., the higher electrical conductivity). In one example, the material having the higher electrical resistivity includes stainless steel, and the material having the lower electrical resistivity includes copper or silver, or aluminum or combinations thereof.

An electrical connection arrangement according to the present disclosure is advantageous to reduce arcing energy during electrical connections and disconnections and for reducing arc related erosion of the connection arrangement. The electrical connection arrangement can be incorporated in a rotary switch and a linear switch.

This present disclosure addresses the above-identified arcing problem with a new and cost-effective solution. The electrical connection arrangement of the rotary switch of the present disclosure includes two contact elements that can be made of two different materials. For example, a first contact element can be made of a higher electrical resistivity material such as stainless steel and a second contact element can be made of a lower electrical resistivity material such as copper, silver, or aluminum. The different materials are sequentially electrically connected during the transitional phase of connecting and disconnecting to help reduce arcing. The linear switch may include four contact elements where the first and second contacts are made of a first material and the third and fourth contacts are made of a second material different from the first material.

One aspect of the present disclosure relates to an electrical switch arrangement for electrically connecting a first electrical conductor to a second electrical conductor. The electrical connection arrangement includes a first circuit path that has a first electrical resistance and a second circuit path has a second electrical resistance that is lower than the first electrical resistance. The electrical switch arrangement is configured to provide a connection sequence for electrically connecting the first and second electrical conductors. The connection sequence includes: a) a first electrical connection state in which the first and second electrical conductors are not electrically connected; b) a second electrical connection state in which the first and second electrical conductors are electrically connected by the first circuit path and are not electrically connected by the second circuit path; c) a third electrical connection state in which the first and second electrical conductors are electrically connected by the first circuit path and by the second circuit path; and d) a fourth electrical connection state in which the first and second electrical conductors are electrically connected by the second circuit path and not by the first circuit path. During the connection sequence the electrical switch arrangement moves from the first electrical connection state, sequentially through the second and third electrical connection states, to the fourth electrical connection state.

Another aspect of the present disclosure relates to an electrical switch arrangement for electrically connecting a first electrical conductor to a second electrical conductor. The electrical connection arrangement includes a first circuit path that has a first electrical impedance and a second circuit path has a second electrical impedance that is lower than the first electrical impedance. The electrical switch arrangement is configured to provide a connection sequence for electrically connecting the first and second electrical conductors. The connection sequence includes: a) a first electrical connection state in which the first and second electrical conductors are not electrically connected; b) a second electrical connection state in which the first and second electrical conductors are electrically connected by the first circuit path and are not electrically connected by the second circuit path; c) a third electrical connection state in which the first and second electrical conductors are electrically connected by the first circuit path and by the second circuit path; and d) a fourth electrical connection state in which the first and second electrical conductors are electrically connected by the second circuit path and not by the first circuit path. During the connection sequence the electrical switch arrangement moves from the first electrical connection state, sequentially through the second and third electrical connection states, to the fourth electrical connection state.

These and other features and advantages will be apparent from a reading of the following detailed description and a review of the associated drawings. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 labeled “prior art” illustrates a top view of an example rotary switch in an open position.

FIG. 2 illustrates a top view of the rotary switch of FIG. 1 in a closed position.

FIGS. 3-7 illustrate a connection sequence of a rotary switch that has an electrical switch arrangement in accordance with principles of the present disclosure.

FIGS. 8-11 illustrate a disconnection sequence of the rotary switch of FIGS. 3-7.

FIG. 12 illustrates an exploded view of a conventional linear switch in an open position.

FIG. 13 illustrates a side cross-sectional view of the linear switch of FIG. 12 in a closed position.

FIGS. 14-17 illustrate a connection sequence of a linear switch that has an electrical switch arrangement in accordance with principles of the present disclosure.

FIGS. 18-20 illustrate a disconnection sequence of the linear switch of FIGS. 14-17.

FIG. 21 illustrates a perspective view of an example two-stage switchgear for use with the electrical switch arrangements of the present disclosure, the two-stage switchgear is shown in an OFF position and includes first and second plungers, first and second sleeves, and a two-way ramp in accordance with the principles of the present disclosure.

FIG. 22 illustrates a perspective view of the two-stage switchgear of FIG. 21 without the first and second sleeves.

FIG. 23 illustrates an exploded view of the two-stage switchgear of FIG. 21.

FIG. 24 illustrates a perspective view of the two-way ramp of FIG. 21.

FIG. 25 illustrates the two-stage switchgear in a mid-way rotational position after rotating the two-way ramp counterclockwise to move the first and second plungers in opposing directions.

FIG. 26 illustrates the two-stage switchgear in an ON position.

FIG. 27 illustrates the two-stage switchgear of FIG. 26 without the first and second sleeves.

### DETAILED DESCRIPTION

Various embodiments of the present invention will be described in detail with reference to the drawings, wherein like reference numerals represent like parts and assemblies throughout the several views. Reference to various embodiments does not limit the scope of the invention. Additionally, any examples set forth in this specification are not intended to be limiting and merely set forth some of the many possible embodiments.

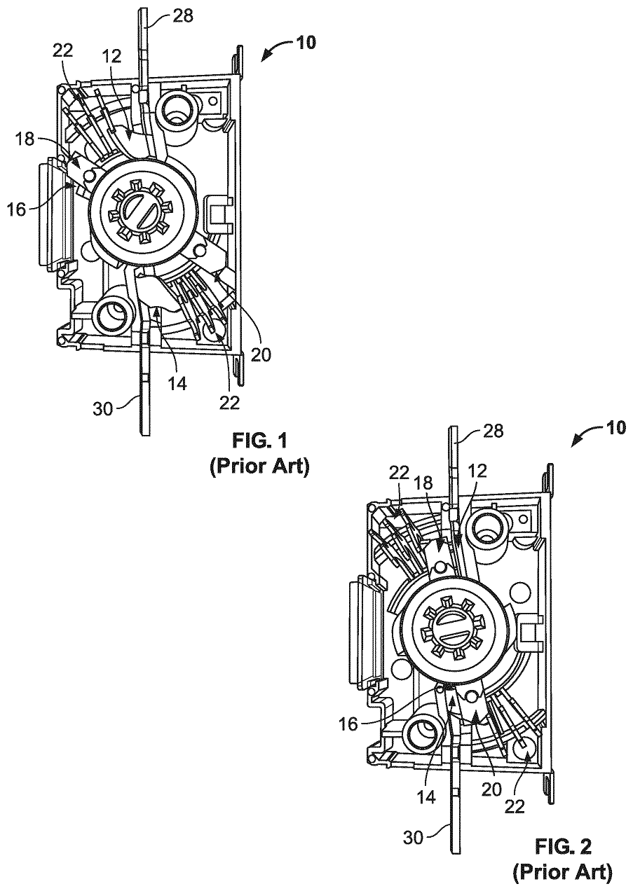

As presented at FIG. 1, a conventional rotary switch 10 is depicted in an open position. The rotary switch 10 can include a first stationary contact 12 and a second stationary contact 14. The rotary switch 10 also includes a rotary contact arm 16 that includes a first movable contact 18 and a second movable contact 20. FIG. 2 shows the rotary switch in a closed position where the rotary contact arm 16 interconnects the first and second stationary contacts 12, 14 with corresponding first and second movable contacts 18, 20.

The rotary switch 10 also includes arc quenching chambers 22 disposed in the vicinity of the contacts to extinguish arc generated when the contacts are operated to be opened or closed. Such arc chambers typically include a plurality of electrically conductive plates and arc transfers to the plates where it is stretched and cooled until extinguished. One of the challenges in current interruption/switching is to drive the arc into the arc interruption chamber.

The present disclosure is also directed to improving electrical switching apparatuses to reduce arcing energy during electrical connections and disconnections made under electrical load. To protect electric installations against the damaging effects of arcing, switches are provided with multiple circuit paths with different electrical resistances that can be utilized in sequence to reduce arc energy and reduce arc related contact and housing erosion. In certain examples, one of the circuit paths can include contacts made of erosion resistance material having a first electrical resistivity, and the other circuit path can include contacts made of a material having a second electrical resistivity lower than the first electrical resistivity.

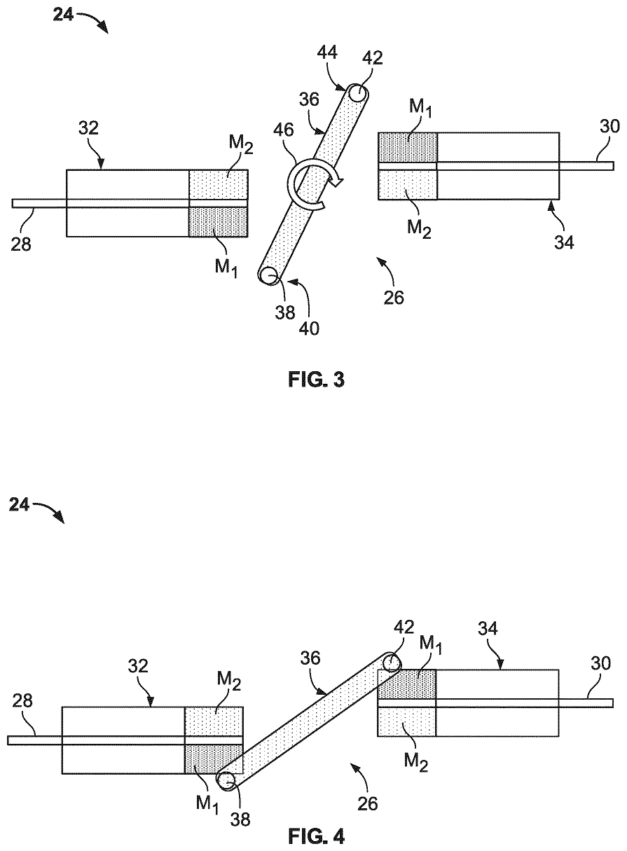

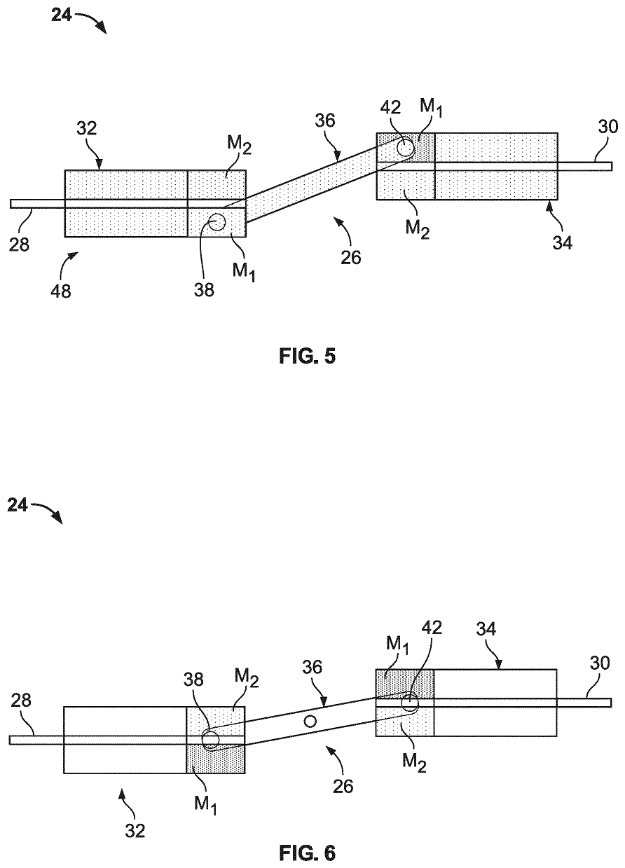

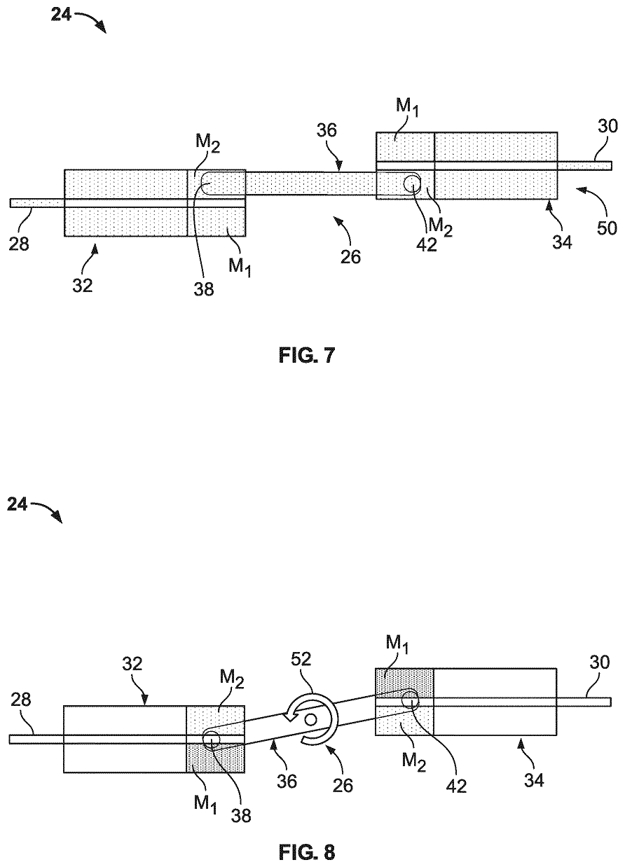

Referring to FIG. 3, an example rotary switch 24 is depicted in accordance with the principles of the present disclosure. The rotary switch 24 can be used within electrical switches (e.g., disconnector) for industrial applications and hazardous applications. FIGS. 3-7 illustrate the rotary switch 24 during connection and FIGS. 8-11 illustrate the rotary switch 24 during disconnection.

The rotary switch 24 includes an electrical connection arrangement 26 (e.g., electrical switch arrangement) in accordance with the principles of the present disclosure for electrically connecting a first electrical conductor 28 to a second electrical conductor 30.

The rotary switch 24 includes a first contact 32 and a second contact 34. The first and second contact 32, 34 can be fixed contacts. The first and second contact 32, 34 can each include two coupled materials separated by an insulation. In certain examples, the two materials can be different materials. In certain examples, one of the materials M₁ has a higher electrical resistivity than the second material M₂ to reduce the arc energy during an electrical disconnection or connection. In certain examples, the first material M₁ may be a more arc erosion resistant material than the second material M₂. In one example, the first material includes stainless steel, and the second material may include copper, silver, nickel, or a combination of copper, siler, and nickel.

In other examples, the first and second contact 32, 34 may be made of the same material. In such a configuration, the first or second electrical conductors 28, 30 may be made of a higher resistance material or alternatively, a resistor may be added to the system.

Still referring to FIG. 3, the rotary switch 24 includes a rotary contact arm 36 (e.g., switch member, rotational switch member) with a first rotating contact 38 at a first end 40 and a second rotating contact 42 at a second end 44. The rotary contact arm 36 rotates in a clockwise direction indicated by arrow 46 to move the first and second rotating contacts 38, 42 of the rotary contact arm 36 relative to the first and second contact 32, 34 between open and closed positions. A shaft (not shown) enables the rotary contact arm 36 to swivel in the direction of the arrow 46.

The electrical connection arrangement 26 of the rotary switch 24 includes a first circuit path 48 (see FIG. 5) that has a first electrical resistance and a second circuit path 50 (see FIG. 7) that has a second electrical resistance lower than the first electrical resistance. In certain examples, a separate resistor may be added for each of the first and second circuit paths 48, 50. In other examples, more than one resistor may be provided, one for each of the first and second circuit paths 48, 50.

During operation, the rotary switch 24 can be actuated to initiate rotational movement of the rotary contact arm 36. For example, an operating handle can interact with a circuit breaker operating mechanism to control the ON and OFF positions of the rotary switch 24.

FIG. 3 shows the rotary contact arm 36 in a first electrical connection state in which the first and second electrical conductors 28, 30 are not electrically connected. That is, the rotary switch 24 is shown in an open position or OFF position. The electrical connection arrangement 26 of the rotary switch 24 can be configured to provide a connection sequence to turn the switch to the ON position for electrically connecting the first and second electrical conductors 28, 30.

The connection sequence can include the following: a) a first electrical connection state (see FIG. 3) in which the first and second electrical conductors 28, 30 are not electrically connected; b) a second electrical connection state (see FIG. 5) in which the first and second electrical conductors 28, 30 are electrically connected by the first circuit path 48 and are not electrically connected by the second circuit path 50; c) a third electrical connection state (see FIG. 6) in which the first and second electrical conductors 28, 30 are electrically connected by the first circuit path 48 and by the second circuit path 50; d) a fourth electrical connection state (see FIG. 7) in which the first and second electrical conductors 28, 30 are electrically connected by the second circuit path 50 and not by the first circuit path 48.

During the connection sequence, the electrical connection arrangement 26 of the rotary switch 24 moves from the first electrical connection state, sequentially through the second and third electrical connection states, to the fourth electrical connection state. The rotary contact arm 36 rotates to transition the electrical switch arrangement 26 between the first, second, third and fourth electrical connection states.

The rotary contact arm 36 is depicted in FIG. 4 to show a positional arrangement between the first electrical connection state and the second electrical connection state. As the rotary contact arm 36 pivots, the first and second rotating contacts 38, 42 can move in contact with first and second contact 32, 34 (see FIG. 5) to provide the second electrical connection state. That is, the first and second rotating contacts 38, 42 rotate to the first material M₁ of the first and second contact 32, 34 to create the first circuit path 48 of high electrical resistance. In the second electrical connection state, current can flow and lead to a small heating of the system due to the high resistance and short contact time.

Turning to FIG. 6, continuous movement of the rotary contact arm 36 allows the first and second rotating contacts 38, 42 move in contact with the low resistance first and second contact 32, 34 (i.e., second material M₂) while also remaining in contact with the high resistance of the first and second contact 32, 34 (i.e., first material M₁) to provide the third electrical connection state. That is, in the third electrical connection state, the first and second circuit paths 48, 50 are connected in parallel. Current can flow mostly over the low-resistance material M₂ of the first and second contact 32, 34. FIG. 7 illustrates the rotary contact arm 36 rotated such that the first and second rotating contacts 38, 42 are in contact with only the low resistance of the first and second contacts 32, 34 (i.e., second material M₂) to provide the fourth electrical connection state. That is, in the fourth electrical connection state, only the second circuit path 50 is connected and the high resistance of the first and second contact 32, 34 (i.e., first material M₁) are separated.

FIGS. 8-11 illustrate a disconnection sequence of the rotary switch 24 in which the rotary contact arm 36 is rotated in a counterclockwise direction indicated by arrow 52. FIG. 8 shows the low and high resistance of the first and second contacts 32, 34 connected back together such that the first and second electrical conductors 28, 30 are electrically connected by both the first and second circuit paths 48, 50.

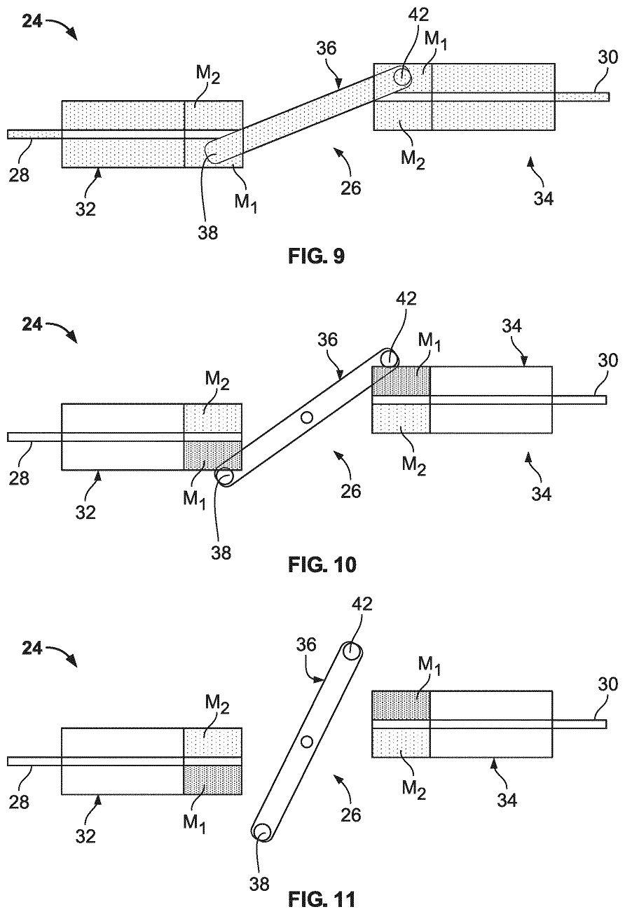

In FIGS. 9-10, the low resistance of the first and second contacts 32, 34 is separated. As such, the first and second electrical conductors 28, 30 are electrically connected by only the first circuit path 48 of high resistance. FIG. 11 shows the first and second electrical conductors 28, 30 electrically disconnected such that there is no current flowing through either one of the first and second circuit paths 48, 50 and the rotary switch 24 is in the open or OFF position.

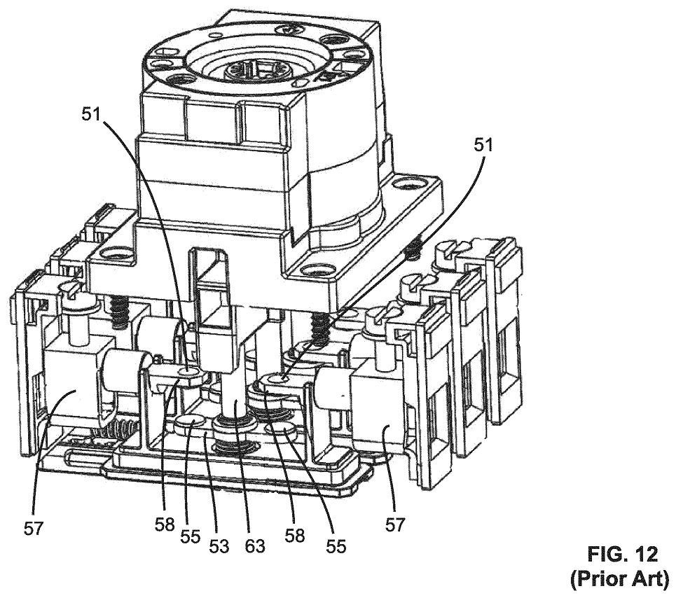

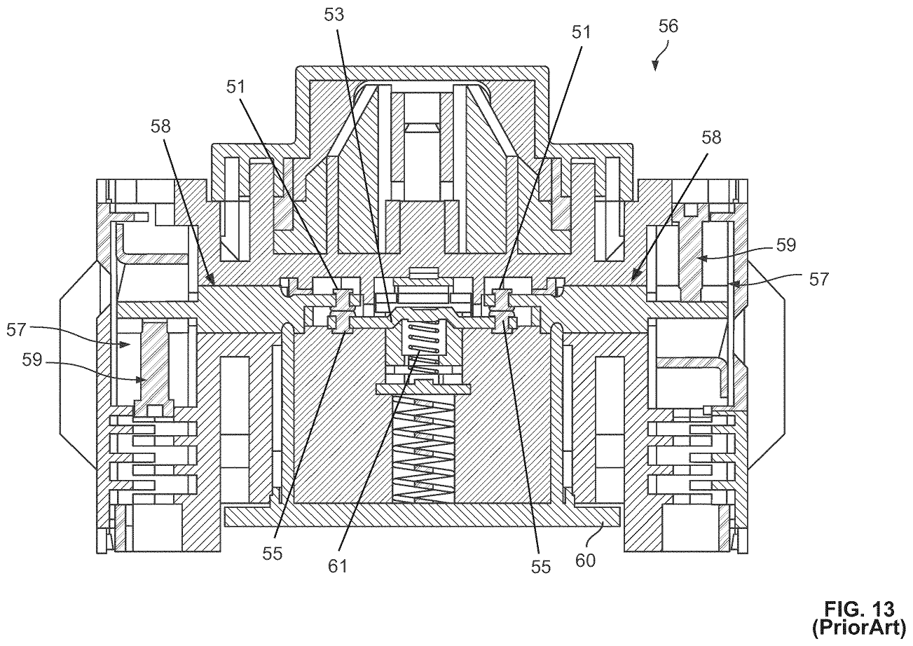

Turning now to FIGS. 12-13, a prior art switching device is depicted. The switching device includes a plurality of linear switches 56 each corresponding to a separate interrupter chamber. Further details for this type of switch is disclosed in PCT Patent Application No. WO 2020/098970, which is incorporated by reference herein in its entirety.

Each of the linear switches 56 includes fixed contacts 58 supported by a base 60. The fixed contacts 58 each include a contact pad 51. The contact pads 51 are separated by a gap that can be closed by a linearly moveable bridge 53 having contact pads 55 aligned with the contact pads 51 of the fixed contacts 58. The fixed contacts 58 include clamps 57 having clamping screws 59 for electrically connecting electrical conductors (e.g., electrical wires/cables) to the fixed contacts 58. The moveable bridge 53 is spring-biased by a spring 61 toward a closed-circuit position (see FIG. 13) in which the contact pads 55 of the bridge 53 contact the contact pads 51 of the fixed contacts 58 such that the fixed contacts 58 are electrically connected to each other by the bridge 53. A cam actuated plunger 63 is adapted to linearly move the bridge 53 away from the fixed contacts 58 against the bias of the spring 61 to an open-circuit position (see FIG. 12) in which the fixed contacts 58 are not electrically connected together by the bridge 53. Actuation of the cam actuated plunger 63 allows the bridge 53 to be moved between the open-circuit position and the closed-circuit positions. An electrical connection is provided between the fixed contacts 58 and the corresponding wires/cables electrically connected thereto when the bridge 53 is in the closed-circuit position. The electrical connection between the fixed contacts 58 is interrupted when the bridge is in the open-circuit position.

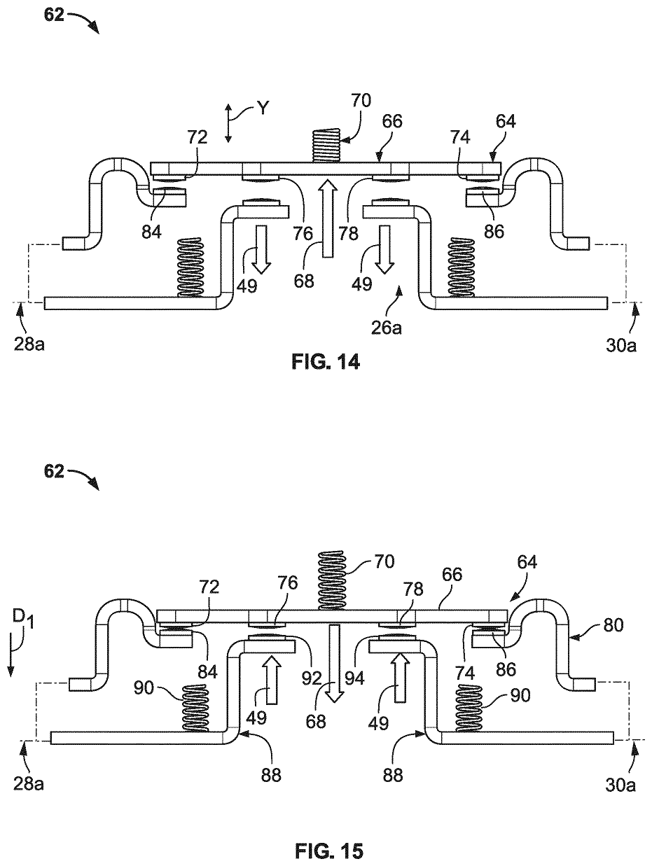

Turning to FIG. 14, another electrical connection arrangement 26a is shown incorporated in a second embodiment as part of a linear double contact switch 62, an electrical switch designed to separate load. The linear double contact switch 62 can include a moveable contact unit 64 that includes a contact bridge 66 (e.g., switch member) that moves linearly along a Y axis. In an open-circuit state, the linear double contact switch 62 is in the OFF position and the contact bridge 66 is open to depict a first electrical connection state in which first and second electrical conductors 28a, 30a are not electrically connected. The contact bridge 66 can be held in the open position due to an axial force indicated by arrow 68. The force indicated by arrow 68 can be applied by an actuator such as a rotary cam actuator and can oppose a spring force generated by compressed spring 70.

The contact bridge 66 includes a first contact 72, a second contact 74, a third contact 76, and a fourth contact 78. In certain examples, the first and second contacts 72, 74 are made of a first material and the third and fourth contacts 76, 78 are made of a second material. Similar to the first and second materials of the first and second contact 32, 34 described above, the first material of the first and second contacts 72, 74 can have a higher electrical resistivity than the second material of the third and fourth contacts 76, 78. In other examples, a resistor may be added to the linear double contact switch 62 to provide different electrical resistances to different circuit pathways in examples where the first, second, third, and fourth contacts 72, 74, 76, 78 are made of the same material. The first and second electrical conductors 28a, 30a and the contact bridge 66 can be made of the second material having the lower electrical resistivity.

Referring to FIGS. 15-17, the electrical connection arrangement 26a can be configured to provide a connection sequence for electrically connecting the first and second electrical conductors 28a, 30a. The electrical connection arrangement 26a includes a first circuit path 80 (see FIG. 15) of higher electrical resistance (i.e., a first electrical resistance) and a second circuit path 82 (see FIG. 17) of lower electrical resistance (i.e., a second electrical resistance) than the first circuit path 80.

In a semi-closed circuit state, an electrical connection can be made through the first circuit path 80 to provide a second electrical connection state as depicted in FIG. 15 in which the first and second electrical conductors 28a, 30a are electrically connected. The first and second electrical conductors 28a, 30a are not electrically connected by the second circuit path 82. For example, by rotating a switch handle of a device, rotational movement will cause the actuator to linearly move the contact bridge 66 in the same direction as the force of the spring 70 (i.e., downward as depicted). Thus, the spring 70 extends (i.e., de-compresses) as the contact bridge 66 moves downwardly. The contact bridge 66 moves downward to a position in which the first and second contacts 72, 74 make physical contact with fixed contacts 84, 86 which are also made of a high resistant material. The contact bridge 66 electrically connects the first and second contacts 72, 74 but does not connect the third and fourth contacts 76, 78 when the electrical switch arrangement 26a is in the second electrical connection state. As the contact bridge 66 moves downwardly, the actuator concurrently forces contacts 92, 94 upwardly and causes compression of springs 90. The contacts 92, 94 are respectively electrically connected to conductors 28a, 30a and are positioned to respectively align with the contacts 76, 78. The springs 90 provide downward spring loading on the contacts 92, 94 which is opposed by the actuator.

The first circuit path 80 includes the first contact 72 electrically connected to the first electrical conductor 28a via the fixed contact 84 and the second contact 74 electrically connected to the second electrical conductor 30a via the fixed contact 86 (see FIG. 15). The second circuit path 82 includes the third contact 76 electrically connected to the first electrical conductor 28a and the fourth contact 78 electrically connected to the second electrical conductor 30a via contacts 92, 94 (see FIG. 17).

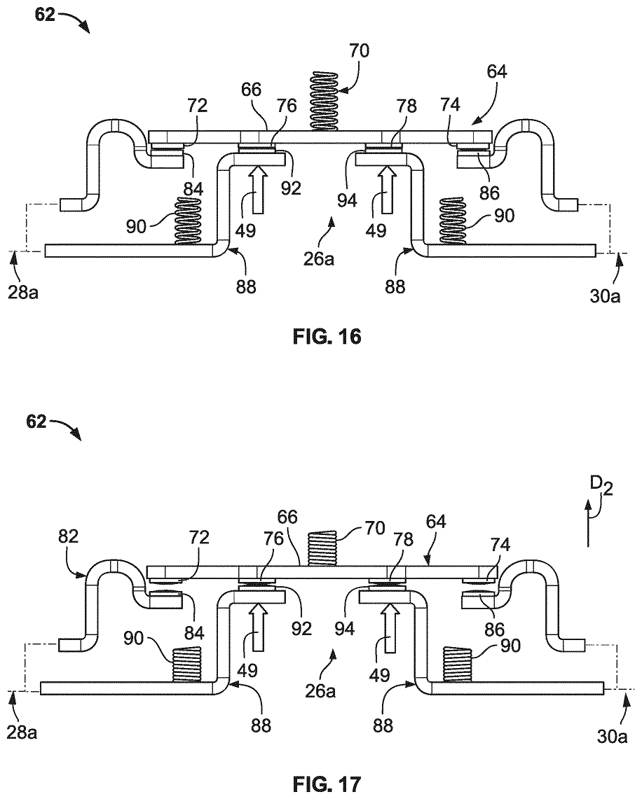

In a closed-circuit state, an electrical connection can be made through the second circuit path to form a third electrical connection state shown in FIG. 16 in which the first and second electrical conductors 28a, 30a are electrically connected by the first circuit path 80 and by the second circuit path 82. The contact bridge 66 is electrically connected to the contacts 84, 86 by the first and second contacts 72, 74 and is also electrically connected to the contacts 92, 94 by the third and fourth contacts 76, 78 when the electrical switch arrangement is in the third electrical connection state. That is, while the contacts 72, 74 remain seated on the contacts 84, 86, the actuator continues upward movement of the lower-resistance contacts 92, 94 until the contacts 92, 94 engage the contacts 76, 78 and the contact bridge 66 provides closed circuits across both the first and second circuit paths 80, 82 simultaneously. But, due to the lower electrical resistance of the second circuit path 82, primary current flow occurs through the second circuit path 82.

A fourth electrical connection state is shown in FIG. 17 in which the first and second electrical conductors 28a, 30a are electrically connected by the second circuit path 82 and not by the first circuit path 80. The contact bridge 66 electrically connects the third and fourth contacts 76, 78 to the contacts 92, 94 and does not connect the first and second contacts 72, 74 to the contacts 84, 86 when the electrical connection arrangement 26a is in the fourth electrical connection state. That is, contacts 92, 94 continue to be moved upwardly by the actuator such that the bridge 66 and the contacts 72, 74 are lifted from the contacts 84, 86. As the bridge 66 and contacts 92, 94 concurrently move upwardly together, the spring 70 is compressed and the springs 90 of the contact elements 88 are further compressed. As such, the first and second contacts 72, 74 separate from the fixed contacts 84, 86 and current flows only through the low resistance material of the third and fourth contacts 76, 78 and the low-resistance contacts 92, 94.

During the connection sequence the electrical switch arrangement 26a moves from the first electrical connection state, sequentially though the second and third electrical connection states, to the fourth electrical connection state. The contact bridge 66 can move linearly in a first direction D₁ (see FIG. 15) to transition the electrical switch arrangement from the first electrical connection state to the second electrical connection state. The contact bridge 66 can move linearly in a second direction D₂ (see FIG. 17) opposite from the first direction to transition the electrical switch arrangement from the third electrical connection state to the fourth electrical connection state.

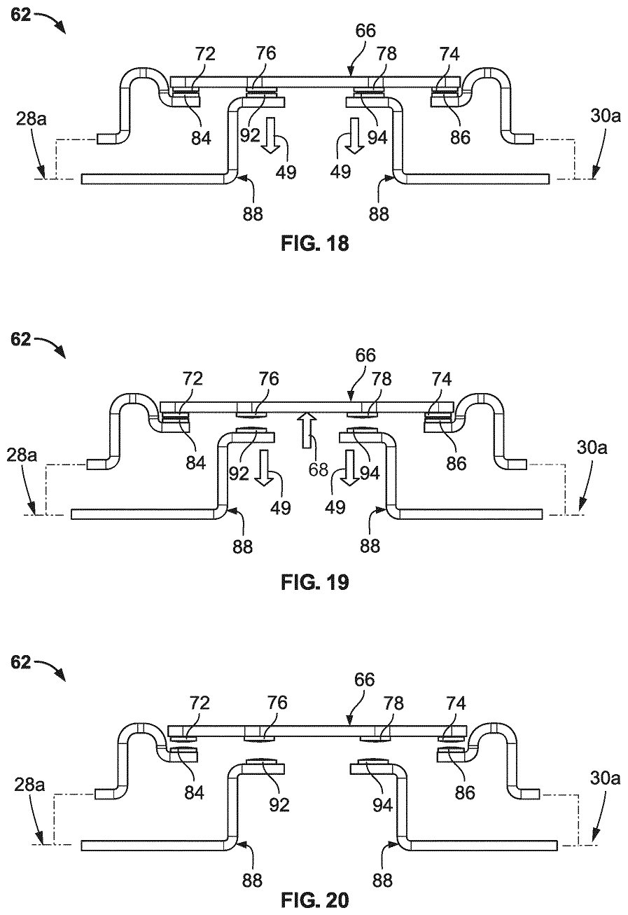

Turning to FIGS. 17-20, the electrical connection arrangement 26a is configured to provide a disconnection sequence for electrically disconnecting the first and second electrical conductors 28a, 30a. During the disconnection sequence the electrical connection arrangement 26a may sequentially move from the fourth electrical connection state (see FIG. 17) through the third and second electrical connection states (see FIGS. 18 and 19) to the first electrical connection state (see FIG. 20). That is, from the state of FIG. 17, the contact bridge 66 and the contacts 92, 94 move along the first direction D₁ such that the first and second contacts contact pin 24 seat upon the fixed contacts 84, 86 as depicted in FIG. 18. Continued downward movement of the contacts 92, 94 transitions the contact arrangement 26a to the semi-opened position where the third and fourth contacts 76, 78 are separated from the low-resistance contacts 92, 94 such that only the low resistance contacts 72, 74, 84, 86 are connected. That is, the first and second electrical conductors 28a, 30a are electrically connected by the first circuit path 80 and are not electrically connected by the second circuit path 82. Finally, the bridge 66 is lifted of the contacts 84, 96 to transition the contact arrangement 26a to an open or OFF circuit position. FIG. 20 shows the electrical connection arrangement 26a in the open or OFF circuit position in which the first and second electrical conductors 28a, 30a are not electrically connected. It will be appreciated that the disconnection sequence can be caused by operation (e.g., rotation) of the cam actuator in the opposite direction from the direction the cam actuator is moved to drive the electrical connection sequence.

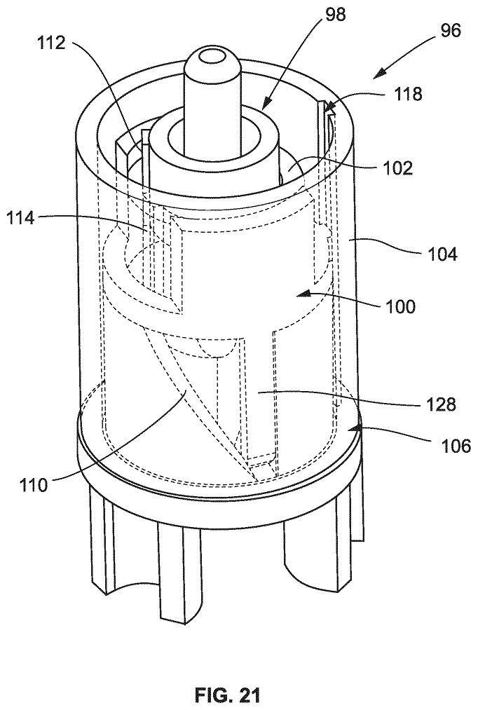

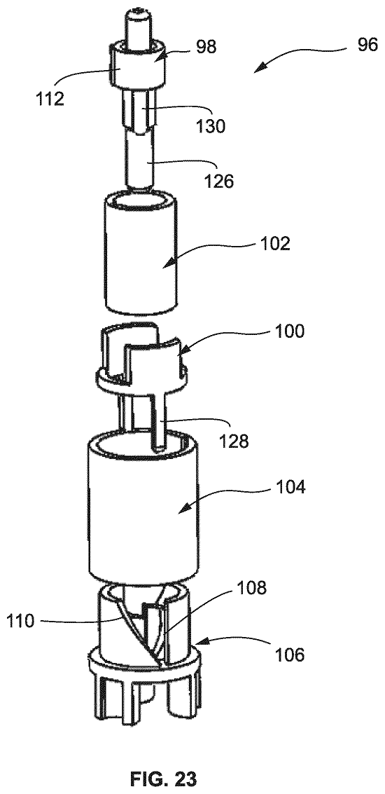

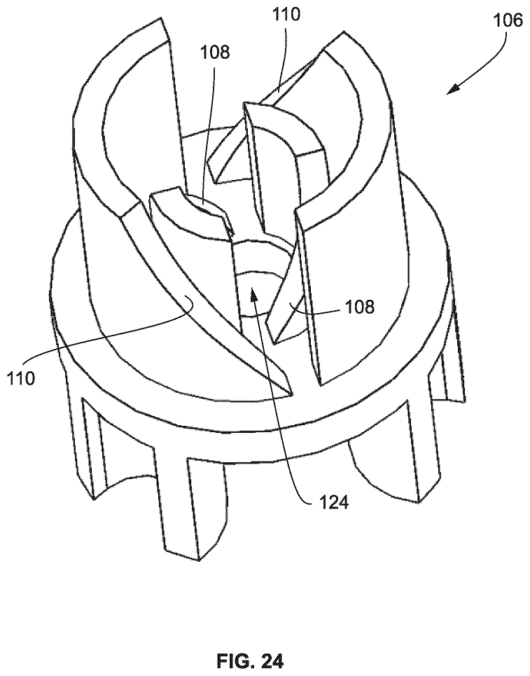

FIGS. 21-27 illustrate a spring biased plunger assembly 96 (e.g., a two-stage switchgear, a spring biased element) for use with the electrical connection arrangement 26a to make the sequence connections described. The spring biased plunger assembly 96 can be movable between the ON and OFF positions for electrically connecting or disconnecting the first and second electrical conductors 28a, 30a.

The spring biased plunger assembly can include multiple plungers that are axially movable in opposing directions along multiple ramps. The ramps can be performed with different pitches to allow different speeds during movement. For example, one plunger may move slower than another plunger.

In the example depicted, the spring biased plunger assembly 96 can include a first plunger 98, a second plunger 100, a first sleeve 102 (e.g., inner sleeve), a second sleeve 104 (e.g., outer sleeve), and a two-way ramp 106 that has inner and outer ramps 108, 110 (see FIG. 24) upon which the first and second plungers 98, 100 move. The inner and outer ramps 108, 110 curve in opposite helical directions such that when the two-way ramp 106 is rotated counterclockwise 120, the first plunger 98 moves downward on the inner ramp 108 and the second plunger 100 moves upward on the outer ramp 110 and when the two-way ramp 106 is rotated clockwise 122, the first plunger 98 moves upward on the inner ramp 108 and the second plunger 100 moves downward on the outer ramp 110. The first plunger 98 can provide the axial movement described above indicated by arrow 68 (see FIG. 14) and the second plunger 100 can provide the opposite axial movement described above indicated by arrows 49 (see FIG. 15).

The first plunger 98 can be slidably carried within the first sleeve 102. The first plunger 98 includes a first guide rail 112 that is configured for reception in a first guide groove 114 defined in the first sleeve 102 for allowing the first plunger 98 to axially move therein. The second plunger 100 can also include a second guide rail 116 that is configured for reception in a second guide groove 118 defined in the second sleeve 104 for allowing the second plunger 100 to axially move therein.

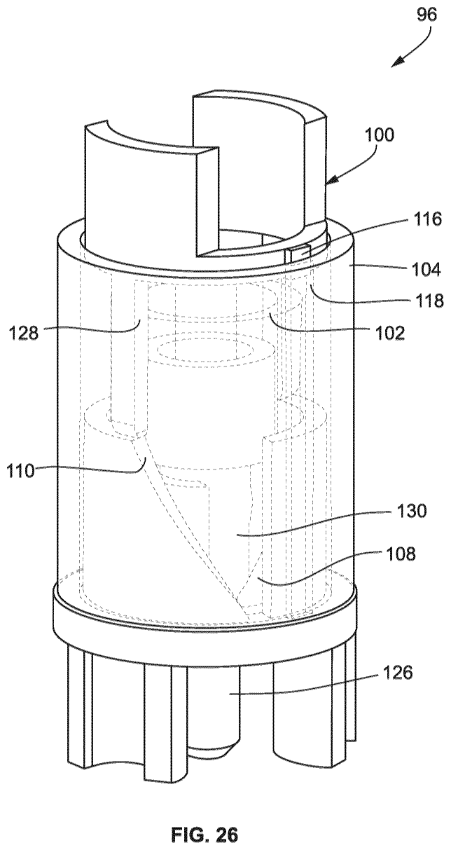

The inner and outer ramps 108, 110 helically curve in opposite directions for driving the respective first and second plungers 98, 100 in opposite directions as the electrical switch arrangement 26a is switched between the On (see FIG. 26) and Off (see FIG. 21) positions for electrically connecting or disconnecting the first and second electrical conductors 28a, 30a.

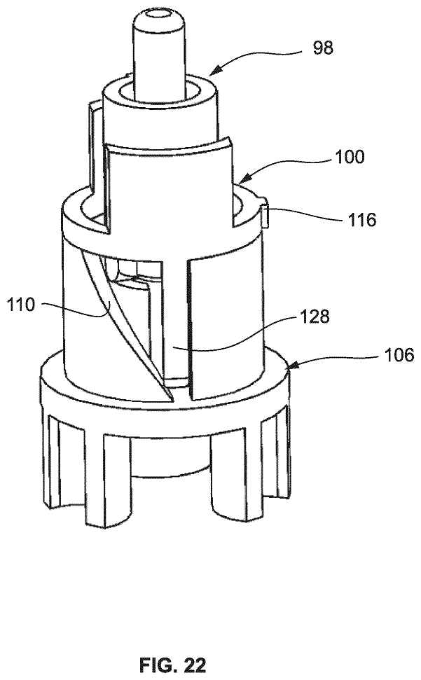

FIG. 21 shows the first plunger 98 in its end position on the inner ramp 108 and the second plunger 100 in its zero position on the outer ramp 110. FIG. 22 illustrates the spring biased plunger assembly 96 in an OFF position without the first and second sleeves 102, 104 shown. When the two-way ramp 106 is rotated counterclockwise shown by arrow 120, the first and second plungers 98, 100 can axially move in opposite directions. That is, the first plunger 98 can move axially in the first direction D₁ while the second plunger moves axially in the second direction D₂. The first plunger 98 can have legs 130 that ride along the inner ramps 108 of the two-way ramp 106. The second plunger 100 can also have legs 128 that ride along the outer ramps 110 of the two-way ramp 106.

When the linear double contact switch 62 is in the open circuit position as shown in FIG. 14, the first plunger 98 can support the contact bridge 66 while the second plunger 100 supports the contacts 92, 94. As the two-way ramp 106 is rotated counterclockwise, the first plunger 98 will ride down on inner ramps 108 due to downward loading from spring 70 causing the contact bridge 66 to lower until the contacts 72, 74 seat on contacts 84, 86 while concurrently the second plunger 100 starts movement in the opposite upward direction to raise the contacts 92, 94 toward the contacts 76, 78 and to compress springs 90.

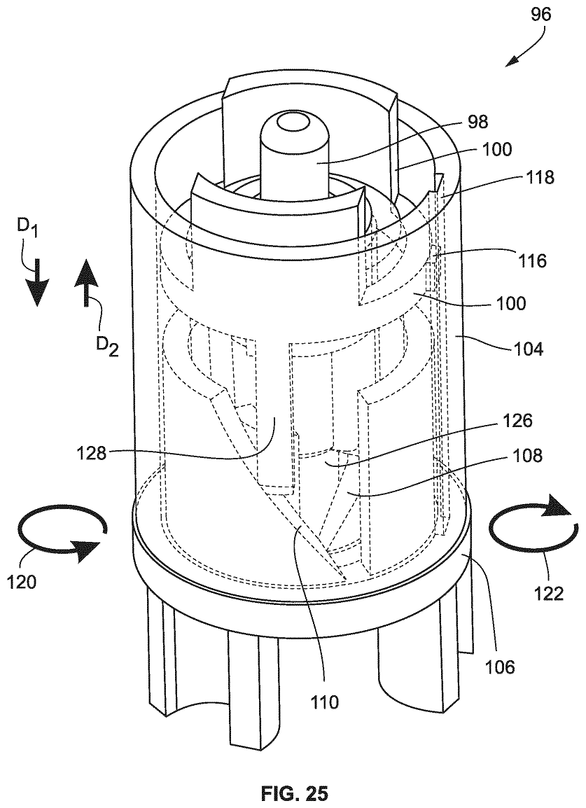

When the two-way ramp 106 continues to rotate counterclockwise, the first and second plungers 98, 100 will continue to move in opposite directions to a mid-way point as shown in FIG. 25. At the mid-way point, the contact bridge 66 can be closed as shown in FIG. 16. The first plunger 98 can continue to move in the first direction D₁ while the second plunger 100 can continue to move in the second direction D₂ which allows the contacts 92, 94 to move upward into contact with the third and fourth contacts 76, 78.

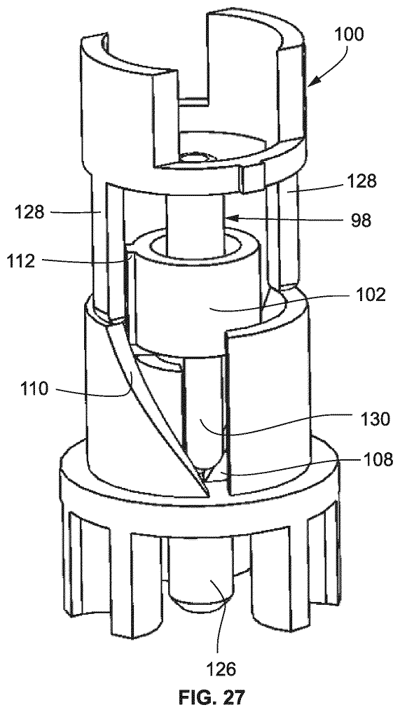

Turning to FIGS. 26-27, continued counterclockwise rotation of the two-way ramp 106 can move the first plunger 98 to its zero position and the second plunger 100 to its end position. In this position, the contact bridge 66 can be raised as shown in FIG. 17 by the second plunger 100 to disconnect the contact between the first and second contacts 72, 74 and the fixed contacts 84, 86 while maintaining the connection between the contact bridge 66 and the contacts 92, 94.

The two-way ramp 106 defines an opening 124 for receiving an extension member 126 of the first plunger 98 as it moves relative to the second plunger 100. In certain examples, a stop (not shown) can be provided within the spring biased plunger assembly 96 to limit axial movement of the first and second plungers 98, 100 by preventing overturning of the two-way ramp 106.

The two-way ramp 106 can be rotated clockwise as indicated by arrow 122 when the electrical connection arrangement 26a is moved from the ON position to the OFF position for electrically disconnecting the first and second electrical conductors 28a, 30a. When the two-way ramp 106 is rotated clockwise to disconnect the linear double contact switch 62, the first plunger 98 can axially move along the inner ramp 108 in the second direction D₂ and the second plunger 100 can axially move along the outer ramp 110 in the first direction D₁ in order to disconnect the first and second electrical conductors 28a, 30a. That is, as the second plunger 100 moves in the first direction D₁, the contacts 92, 94 can move downward to separate the connection between the third and fourth contacts 76, 78 and the low-resistance contacts 92, 94. Continued clockwise rotation of the two-way ramp 106 continues movement of the first plunger 98 in the second direction D₂ and the second plunger 100 in the first direction D₂ to lift the contact bridge 66 and disconnect the first and second contacts 72, 74 from the fixed contacts 84, 86.

From the forgoing detailed description, it will be evident that modifications and variations can be made without departing from the scope of the claims.

1. An electrical switch arrangement for electrically connecting a first electrical conductor to a second electrical conductor, the electrical switch arrangement comprising:
a first circuit path having a first electrical resistance;
a second circuit path having a second electrical resistance that is lower than the first electrical resistance; and
the electrical switch arrangement being configured to provide a connection sequence for electrically connecting the first and second electrical conductors, the connection sequence including: a) a first electrical connection state in which the first and second electrical conductors are not electrically connected; b) a second electrical connection state in which the first and second electrical conductors are electrically connected by a first circuit path and are not electrically connected by the second circuit path; c) a third electrical connection state in which the first and second electrical conductors are electrically connected by the first circuit path and by the second circuit path; and d) a fourth electrical connection state in which the first and second electrical conductors are electrically connected by the second circuit path and not by the first circuit path, wherein during the connection sequence, the electrical switch arrangement moves from the first electrical connection state, sequentially through the second and third electrical connection states, to the fourth electrical connection state.

2. An electrical switch arrangement for electrically connecting a first electrical conductor to a second electrical conductor, the electrical switch arrangement comprising:
a first circuit path having a first electrical impedance;
a second circuit path having a second electrical impedance that is lower than the first electrical impedance; and
the electrical switch arrangement being configured to provide a connection sequence for electrically connecting the first and second electrical conductors, the connection sequence including: a) a first electrical connection state in which the first and second electrical conductors are not electrically connected; b) a second electrical connection state in which the first and second electrical conductors are electrically connected by a first circuit path and are not electrically connected by the second circuit path; c) a third electrical connection state in which the first and second electrical conductors are electrically connected by the first circuit path and by the second circuit path; and d) a fourth electrical connection state in which the first and second electrical conductors are electrically connected by the second circuit path and not by the first circuit path, wherein during the connection sequence, the electrical switch arrangement moves from the first electrical connection state, sequentially through the second and third electrical connection states, to the fourth electrical connection state.

3. The electrical switch arrangement of claim 1, wherein the electrical switch arrangement includes a rotary switch arrangement.

4. The electrical switch arrangement of claim 1, wherein the electrical switch arrangement includes a linear switch arrangement.

5. The electrical switch arrangement of claim 1, wherein the first circuit path includes a first contact electrically connected to the first electrical conductor and a second contact electrically connected to the second electrical conductor, wherein the second circuit path includes a third contact electrically connected to the first electrical conductor and a fourth contact electrically connected to the second electrical conductor, and wherein the electrical switch arrangement includes a switch member that: a) electrically connects the first and second contacts and does not connect the third and fourth contacts when the electrical switch arrangement is in the second electrical connection state; b) electrically connects the first and second contacts and also electrically connects the third and fourth contacts when the electrical switch arrangement is in the third electrical connection state; and c) electrically connects the third and fourth contacts and does not connect the first and second contacts when the electrical switch arrangement is in the fourth electrical connection state.

6. The electrical switch arrangement of claim 5, wherein the switch member is a rotational switch member that rotates to transition the switch arrangement between the first, second, third, and fourth electrical connection states.

7. The electrical switch arrangement of claim 5, wherein the first and second contacts are made of a first material and the third and fourth contacts are made of a second material, wherein the first material has a higher electrical resistivity and is more erosion resistant than the second material.

8. The electrical switch arrangement of claim 7, wherein the first material includes stainless steel, and the second material includes copper, silver, or nickel, or combinations thereof.

9. The electrical switch arrangement of claim 5, wherein the switch member moves linearly.

10. The electrical switch arrangement of claim 9, wherein the switch member moves linearly in a first direction to transition the electrical switch arrangement from the first electrical connection state to the second electrical connection state, and wherein the switch member moves linearly in a second direction opposite from the first direction to transition the electrical switch arrangement from the third electrical connection state to the fourth electrical connection state.

11. The electrical switch arrangement of claim 5, wherein the first, second, third, and fourth contacts are made of the same material composition of a lower electrical resistivity.

12. The electrical switch arrangement of claim 11, further comprising a resistor made of a higher resistance material.

13. The electrical switch arrangement of claim 1, further comprising a spring biased element configured to provide a mechanical force in the electrical switch arrangement for connecting or disconnecting the first and second electrical conductors.

14. The electrical switch arrangement of claim 13, wherein the spring biased element includes first and second plungers axially movable in opposing directions along a two-way ramp.

15. The electrical switch arrangement of claim 14, wherein the first and second plungers are axially movable within respective first and second sleeves upon rotation of the two-way ramp in a clockwise or counterclockwise direction.

16. The electrical switch arrangement of claim 15, wherein the first plunger is axially movable along inner ramps of the two-way ramp and the second plunger is axially movable along outer ramps of the two-way ramp.

17. The electrical switch arrangement of claim 13, wherein the spring biased element includes multiple elements configured to transfer rotational movement into linear movement.

18. The electrical switch arrangement of claim 17, wherein the multiple elements include plungers that are axially movable in opposing directions along multiple ramps.
